(19) United States
(12) Patent Application Publication
(10) Pub. No.: US 2005/0191120 A1
(43) Pub. Date: Sep. 1, 2005

(54) Damped ball joint

(76) Inventor: Hans-Gerd Oellers, Moenchengladbach (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/066,825

(22) Filed: Feb. 25, 2005

(30) Foreign Application Priority Data
Feb. 27, 2004 (DE) 20 2004 003 017.9

(51) Int. Cl. F16D 1/12

(52) U.S. Cl. 403/133

(57) ABSTRACT

A damped ball joint includes a socket bush (30) having an outer wall, a ball socket (14) arranged in the socket bush (30), a ball pin (16) held in the ball socket (14), a casing bush (32) having an inner wall and being arranged concentrically outside the socket bush (30), and an elastomer body (34) provided between the socket bush (30) and the casing bush (32). The elastomer body (34) has at least one stop section (38) which, in an unstressed state of the ball joint, does not lie simultaneously against the outer wall of the socket bush (30) and the inner wall of the casing bush (32).

### BACKGROUND OF THE INVENTION

The invention relates to a damped ball joint.

Damped ball joints are used in vehicles, in particular in chassis components of motor vehicles such as track rods and stabilizer coupling struts. In travelling operation the joints are exposed to alternating stresses in axial and radial direction. In order to counteract these stresses, currently dampers are used which are made of cylindrical rubber/metal combinations. The dampers, which are stressed in alternating load applications with regard to thrust, are arranged substantially in axial direction of the corresponding vehicle components, the axial direction corresponding to the axial direction of the pin shaft of the ball joint or of an axial joint coupled to the ball joint. In order to include such dampers structurally, the shafts are constructed so as to be quite bulky. This may lead to problems with surrounding components. A further disadvantage is the considerable increase in weight of the joint.

German utility model DE 93 18 586 U1 shows a ball joint comprising a socket bush, a ball socket arranged in the socket bush, a ball pin held in the ball socket, and a casing bush arranged concentrically outside the socket bush. An elastomer sleeve is arranged between the socket bush and the casing bush of the ball joint. To improve the radial damping, the elastomer sleeve is provided with notches at several points.

It is an object of the invention to provide a ball joint enabling an improved absorbing or reducing of introduced stresses.

### BRIEF SUMMARY OF THE INVENTION

The ball joint according to the invention comprises a socket bush having an outer wall, a ball socket arranged in the socket bush, a ball pin held in the ball socket, a casing bush having an inner wall and being arranged concentrically outside the socket bush, and an elastomer body provided between the socket bush and the casing bush. The elastomer body has at least one stop section which, in an unstressed state of the ball joint, does not lie simultaneously against the outer wall of the socket bush and the inner wall of the casing bush. Thus, in particular, radially acting forces introduced via the socket bush of the ball joint can be effectively damped. If the ball joint according to the invention is used in a vehicle steering system, the oscillation and shock stresses introduced via the wheels during travelling operation can be reduced. This contributes to a reduction in wear of the intercalated components, to a gentler response behaviour of the steering and therefore to an increase in steering comfort.

In order to achieve an initially linear and, with increasing stress of the socket bush of the ball joint, a progressive damping characteristics, the stop section lies against the outer wall of the socket bush and is spaced apart from the inner wall of the casing bush.

To improve the damping behaviour upon tensile and compressive stresses, provision is made that the elastomer body has at least two opposite stop sections.

On introduction of stresses via a joint shaft of the ball joint, optimum damping results are achieved in that the stop section is aligned to the longitudinal axis of the joint shaft.

The damping in the axial direction of the ball joint, as defined by the orientation of the ball pin, can be improved by an encircling elastomer layer provided on at least one of the two end faces of the socket bush.

The construction of the ball joint can be simplified in that the socket bush, the casing bush and the elastomer body are part of a pre-assembled damper bearing which is inserted into a joint head of the ball joint.

### BRIEF DESCRIPTION OF THE DRAWINGS

FIG. 1 shows a sectional side view of the individual parts of a ball joint according to the invention;

FIG. 2 shows an enlarged top view of the damper bearing of the ball joint;

FIG. 3 shows a top view of the joint head and the joint shaft of the ball joint;

FIG. 4 shows a side view, partially in section, of the composed ball joint connected with an axial joint; and

FIG. 5 shows a diagram to illustrate the damping behaviour of the ball joint with tensile and compressive stress.

### DETAILED DESCRIPTION OF THE INVENTION

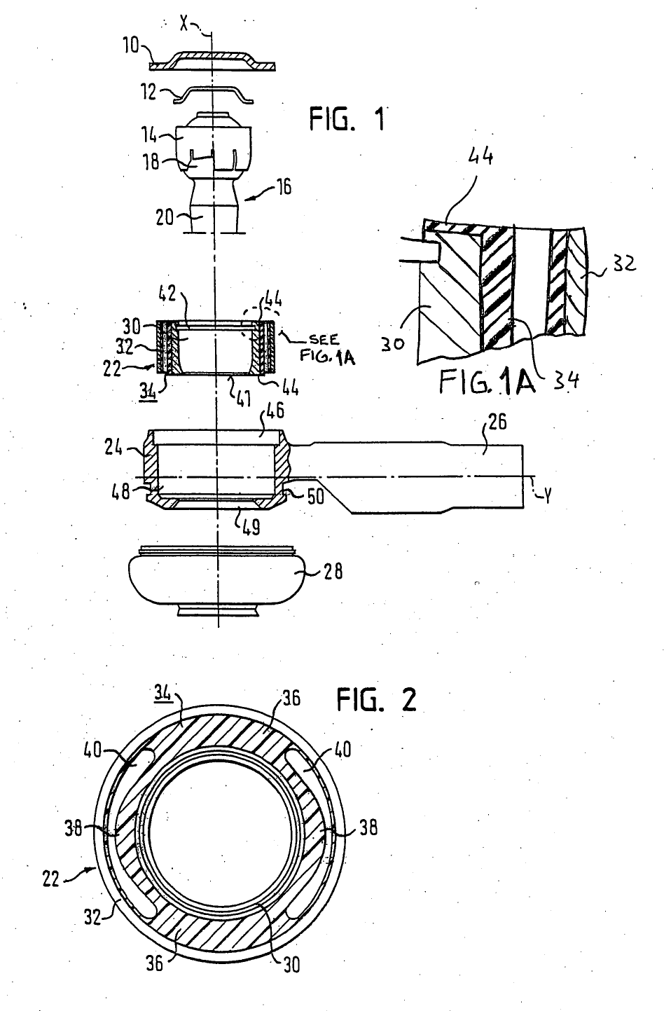

The ball joint described below consists substantially of the following components illustrated in FIG. 1: a closure cover 10; a plate spring 12; a ball socket 14; a ball pin 16 held in the ball socket 14 and having a ball head 18 and a pin shaft 20; a damper bearing 22; a joint head 24 with formed-on joint shaft 26; and a sealing element 28.

The damper bearing 22 is made up of a socket bush 30 and a concentrically spaced apart outer casing bush 32 (in relation to the longitudinal axis X of the ball joint defined by the longitudinal axis of the pin shaft 20). Between the socket bush 30 and the casing bush 32 an elastomer body 34 is arranged. The elastomer body 34 is firmly connected via two opposite holding sections 36 both to the outer wall of the socket bush 30 and the inner wall of the casing bush 32 (see FIG. 2). Viewed in peripheral direction of the bushes 30, 32, the elastomer body 34 has two opposite, bead-like stop sections 38. The staggered stop sections 38 are offset with respect to the holding sections 36, which are spaced apart from the inner wall of the casing bush 32. The elastomer-free intermediate spaces 40 thus formed in peripheral direction between the holding sections 36 represent functional zones, the mode of operation of which will be explained later.

The socket bush 30 has a substantially cylindrical interior space which changes at one end face into a ball shape having an opening 41 for the pin shaft 20 of the ball pin 16. At the other end face of the socket bush 30, an encircling radial bearing groove 42 is formed. On both of the end faces of the socket bush 30 an encircling elastomer layer 44 is provided.

The interior space of the joint head 24 is defined by a multi-stepped bore. The interior space is composed of a first section 46 with a larger diameter and a second section 48 with a smaller diameter which changes into an end-face passage opening 49 for the pin shaft 20 of the ball pin 16.

On assembly of the ball joint, at first a structural unit consisting of the ball socket 14, the ball pin 16 and a grease filling is inserted into the interior space of the socket bush 30. By means of the preformed plate spring 12, the arm ends of which are fixed under prestress in the bearing groove 42, an axial pressure is exerted onto the ball socket 14 via the convex central cross-piece of the plate spring 12. Thus, the rotational and tilting moments are controlled, and an adjustment of the ball socket 14 in the case of wear is provided for.

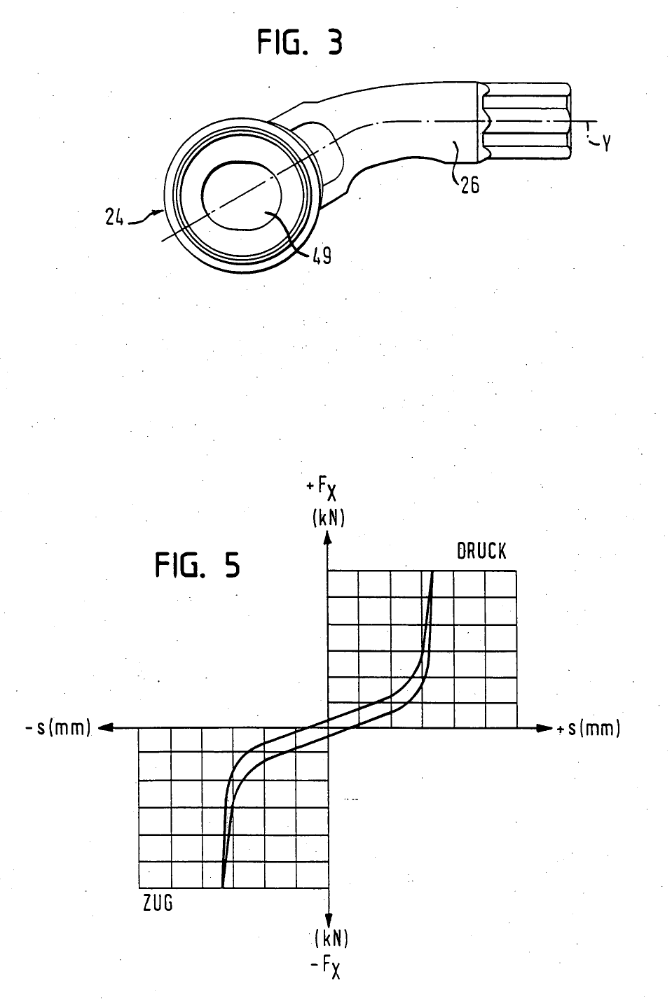

The damper bearing 22 is inserted into the joint head 24 onto the radial shoulder of the stepped bore formed between the second section 48 and the passage opening 49, so that the stop sections 38 of the elastomer body 34 are aligned parallel to the longitudinal axis Y of the joint shaft 26 (see FIG. 2). By means of suitable measures, the damper bearing 22 is secured axially and radially. A relative small gap dimension is kept between the shoulder of the stepped bore and the elastomer layer 44 encircling the end face of the socket bush 30. The passage opening 49 of the stepped bore is constructed parallel to the longitudinal direction Y of the joint shaft as an elongated hole (see FIG. 3) with a steel covering towards the socket bush 30 as security against so-called misuse forces in extraction direction (directed downwards in FIG. 1).

The sealing element 28 is supported on the one hand in an external radial groove 50 of the joint head 24 and on the other hand on the pin shaft 20 of the ball pin 16 by means of suitable clamping elements, and thus protects the ball joint from external influences.

Above the damper bearing 22, the cap-shaped closure cover 10 is inserted into the first section 46 of the interior space of the joint head 24. The closure cover 10 is fixed, for example, by bending over the edge of the joint head 24 surrounding the first section 46. The closure cover 10 seals the ball joint off against external influences and serves as security against misuse forces in the pressing-out direction (directed upwards in FIG. 1). Here also, a small gap dimension is kept between the base of the closure cover 10 and the elastomer layer 44 encircling the end face of the socket bush 30.

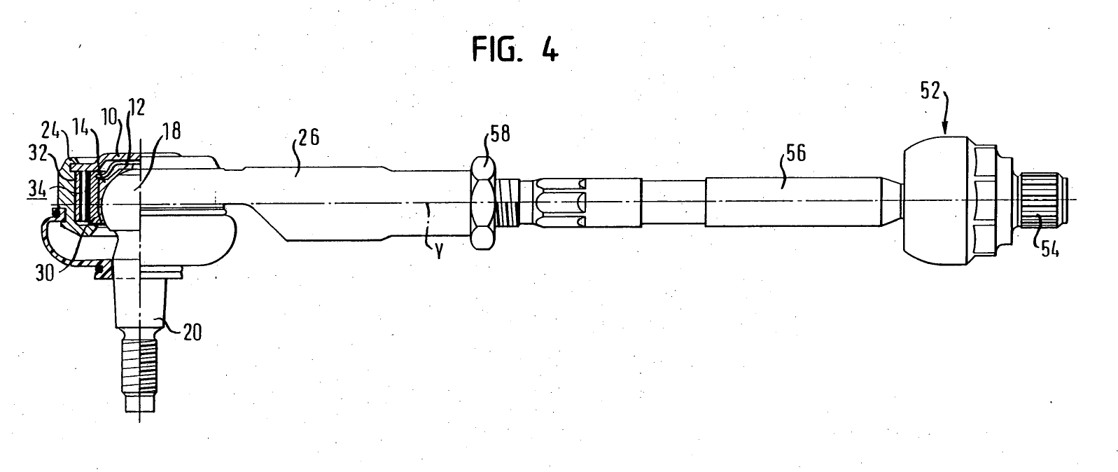

The ball joint can be used, for example, in a steering system of a motor vehicle for coupling the track link steering arm to the steering gear. For this, the ball joint is fastened via a thread of the pin shaft 20 on the track link steering arm. The connecting to the steering gear is undertaken by an axial joint 52 (see FIG. 4). The axial joint 52 comprises an axial housing pin 54, which represents the connection to the steering rack of the steering system, and a threaded pin 56. By means of the external thread of the threaded pin 56, matching the internal thread of the joint shaft 26, the axial joint 52 and the ball joint are connected with each other so as to be longitudinally adjustable. The connection is secured by means of a hexagonal nut 58.

The hysteresis-type behaviour of the “elastic rigidity” of the ball joint as a function of an introduced tensile or compressive stress onto the socket bush 30 in axial direction of the track rod is illustrated in FIG. 5. By means of the socket bush 30, the elastomer body 34 is acted upon radially by a combined thrust/pressure force. In the first phase of the traction or pressure action, owing to the elastomer-free function zones 40, the ball joint firstly shows a defined, linearly rising elastic rigidity. As soon as the corresponding stop section 38 of the elastomer body 34 comes into abutment with the inner wall of the casing bush 32, the stop section 38 then takes up the further deformation work and therefore represents a damped stop with a progressive elastic rigidity.

By means of an increase/reduction of the elastomer component of the elastomer body 34 and/or different Shore hardnesses, various rigidities of the damping can be realized. Furthermore, the damping behaviour can be influenced by means of the shaping, in particular by the extent of the stop sections 38. Different shapes of the two stop sections 38 are also conceivable. A different number of stop sections 38 and/or holding sections 36 and/or a different arrangement in peripheral direction can also be provided.

With a stress application of the ball pin 16 in the direction of the longitudinal axis X, the ball joint is stressed with regard to thrust. In this case the elastomer layers 44 encircling the end face of the socket bush 30, bring about a damped stop.

1. A damped ball joint, comprising a socket bush having an outer wall, a ball socket arranged in the socket bush, a ball pin held in the ball socket, a casing bush having an inner wall and being arranged concentrically outside the socket bush, and an elastomer body provided between the socket bush and the casing bush, the elastomer body having at least one stop section, which, in an unstressed state of the ball joint, does not lie simultaneously against the outer wall of the socket bush and the inner wall of the casing bush.

2. The ball joint according to claim 1, wherein the stop section lies against the outer wall of the socket bush and is spaced apart from the inner wall of the casing bush.

3. The ball joint according to claim 1, wherein the elastomer body has at least two opposite stop sections.

4. The ball joint according to claim 1, wherein the elastomer body has at least one holding section lying both against the outer wall of the socket bush and also against the inner wall of the casing bush.

5. The ball joint according to claim 4, wherein the stop sections and the holding sections are arranged staggered with respect to each other in peripheral direction of the bushes.

6. The ball joint according to claim 1, wherein the ball joint further comprises a joint shaft having a longitudinal axis, the stop section being aligned to the longitudinal axis of the joint shaft.

7. The ball joint according to claim 1, wherein the socket bush has two end faces, an encircling elastomer layer being provided on at least one of the two end faces of the socket bush.

8. The ball joint according to claim 1, wherein the ball joint further comprises a joint head, the socket bush, the casing bush and the elastomer body being part of a pre-assembled damper bearing which is inserted into the joint head of the ball joint.

9. The ball joint according to claim 8, wherein the joint head has an inner wall, the inner wall of the joint head being provided at least partially with a steel covering towards the socket bush.

10. The ball joint according to claim 1, wherein the ball joint further comprises a pre-formed plate spring having a central cross-piece and arm ends, an encircling radial bearing groove being formed in the socket bush, the arm ends of a the-formed plate spring being fixed under prestress in the bearing groove, so that an axial pressure is exerted onto the ball socket by the central cross-piece of the plate spring.
